(19) United States
(12) Patent Application Publication
(10) Pub. No.: US 2025/0315719 A1
(43) Pub. Date: Oct. 9, 2025

(54) PERFORMANCE EVALUATION OF GENERATIVE QUESTION-ANSWERING SYSTEMS

(71) Applicant: Microsoft Technology Licensing, LLC, Redmond, WA (US)

(72) Inventors: Laurent BOUÉ, Petah Tikva (IL); Yasmin BOKOBZA, Ramat Gan (IL); Kiran RAMA, Bangalore (IN); Naveen PANWAR, Bangalore (IN)

(21) Appl. No.: 18/627,828

(22) Filed: Apr. 5, 2024

(51) Int. Cl. G06N 20/00

(52) U.S. Cl. CPC G06N 20/00

(57) ABSTRACT

Systems and methods are disclosed herein for evaluating the performance of a question-answering model. In an example system, a set of prior question-answer pairs is obtained. In an example, each prior question-answer pair comprising a question and an associated answer that was generated previously. Each prior question-answer pair is provided to a LLM to obtain an evaluation score for the prior question-answer pair. In an embodiment, the evaluation score contains a value indicative of a quality of the answer to the question. An evaluation model is trained using features and labels, where the features are based on each prior question-answer pair and the labels are based on the evaluation score for each prior question-answer pair. When a current question-answer pair is obtained (e.g., for evaluation), the evaluation model is applied to the current question-answer pair to generate an evaluation score.

### BACKGROUND

Generative question-answering systems in the realm of generative artificial intelligence (AI) are being deployed across various applications and environments, such as in search engines and recommender systems. While these generative AI systems are typically useful in their deployed settings, evaluating the accuracy of these systems can pose significant challenges. For instance, assessing the relevance of answers generated by these generative AI systems often relies upon expensive human expert validations, where an individual that is knowledgeable about a certain field must analyze each question and answer to determine how accurate the generated answer is.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods are disclosed herein for evaluating the performance of a question-answering model. In an example system, a set of prior question-answer pairs is obtained. In an example, each prior question-answer pair comprising a question and an associated answer that was generated previously. Each prior question-answer pair is provided to a LLM to obtain an evaluation score for the prior question-answer pair. In an embodiment, the evaluation score contains a value indicative of a quality of the answer to the question. An evaluation model is trained using features and labels, where the features are based on each prior question-answer pair and the labels are based on the evaluation score for each prior question-answer pair. When a current question-answer pair is obtained (e.g., for evaluation), the evaluation model is applied to the current question-answer pair to generate an evaluation score. In this manner, the performance of a model used to generate an answer to a question can be evaluated with reduced latency and reduced utilization of compute resources, among other benefits described herein.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for evaluating the performance of a question-answering model, in accordance with an example embodiment.

FIG. 2 shows a block diagram of a system for evaluating a question-answer pair, in accordance with an example embodiment.

FIG. 3 shows a flowchart of a method for evaluating the performance of a question-answering model, in accordance with an example embodiment.

FIG. 4 shows a block diagram of a system for scoring a question-answer pair using multiple judges, in accordance with an example embodiment.

FIG. 5 shows a flowchart of a method for generating an evaluation model using a plurality of judges, in accordance with an example embodiment.

FIG. 6 shows a flowchart of a method for receiving an evaluation score in response to generating a prompt for an LLM, in accordance with an example embodiment.

FIG. 7 shows a flowchart of a method for providing a rating based on an evaluation score, in accordance with an example embodiment.

FIG. 8 shows a block diagram of a system for filtering a set of set of question-answer pairs, in accordance with an example embodiment.

FIG. 9 shows a flowchart of a method of a method for applying a filtering criteria to a chat history, in accordance with an example embodiment.

FIG. 10 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Generative question-answering systems in the realm of generative AI are being deployed across various applications and environments, such as in search engines and recommender systems. While these generative AI systems are typically useful in their deployed settings, evaluating the accuracy of these systems can pose significant challenges. For instance, assessing the relevance of answers generated by these generative AI systems often relies upon expensive human expert validations, where an individual that is knowledgeable about a certain field must analyze each question and answer to determine how accurate the generated answer is.

To address this problem, application programming interface (API) calls can be made to a large language model (LLM) to evaluate a particular answer. However, such an approach is cost-intensive, as the LLM is queried (e.g., using a new API call) for each individual answer, even if that same or similar answer was evaluated in the past. Such an approach takes additional time and is costly, due to the unbounded number of API calls needed.

Embodiments described herein are directed to evaluating the performance of a question-answering model. In an example system, a set of prior question-answer pairs is obtained. In an example, each prior question-answer pair comprising a question and an associated answer that was generated previously. Each prior question-answer pair is provided to a LLM to obtain an evaluation score for the prior question-answer pair. In an embodiment, the evaluation score contains a value indicative of a quality of the answer to the question. An evaluation model is trained using features and labels, where the features are based on each prior question-answer pair and the labels are based on the evaluation score for each prior question-answer pair. When a current question-answer pair is obtained (e.g., for evaluation), the evaluation model is applied to the current question-answer pair to generate an evaluation score.

Accordingly, example embodiments are directed to techniques for training a machine learning model to evaluate a question-answering model, such as an LLM. Example embodiments described herein advantageously provide improvements in various areas of computing, including but not limited to, a reduction in the number of processing cycles used for evaluating a question-answering model. For instance, by providing a dataset of past question-answer pairs to an LLM to obtain evaluation scores indicative of the relevance between the questions and associated answers, the evaluation scores is learned and modeled into a surrogate machine learning model. In various examples, this surrogate machine learning model used to evaluate new question-answer pairs is a regression model that utilizes few processing cycles during inference compared to LLMs (e.g., computation due to LLM operations are reduced), thereby resulting in a reduction in processing resources utilized when a new question-answer pair is evaluated.

In addition, in various embodiments, the surrogate evaluation model is stored and/or accessible in a manner that reduces or even eliminates the need for additional LLM calls for purposes of evaluating a question-answer pair. Rather, the model is accessed and/or applied in a different fashion (e.g., without the need of an API call), thereby further reducing the processing resources required. In accordance with the disclosed techniques, a bounded set of LLM calls are made during training phase of the evaluation model, after which LLM calls need not be made for evaluating a question-answer pair. Rather, during evaluation, the question-answer pair is applied to the trained evaluation model (rather than the LLM). Such techniques are in contrast with other approaches in which the number of LLM calls (e.g., API calls, which result in increased costs) grow linearly with every question-answer pair that needs evaluation. In addition, because a surrogate evaluation model is utilized (rather than a LLM that utilizes more compute power and is often accessed through a remote server), question-answer pair evaluations are performed in a quicker fashion (i.e., shorter inference time), thereby reducing the latency in evaluating the quality of answers provided by question-answering model.

Still further, the model is stored locally in various examples, allowing for a reduction in network resource usage compared to other techniques in which LLM calls are utilized (which require network usage each time a question-answer pair is evaluated). Thus, by learning how evaluation scores are generated using a set of prior question-answer pairs, a surrogate model is trained that results in various computing system improvements.

Still further, example embodiments described herein advantageously improve the performance of question-answering systems (e.g., including planner/orchestrators, LLMs, etc.). In particular, real-time (or near real-time) feedback indicative of the quality of answers is generated, such that a feedback signal can be provided to various components of a question-answering system. These feedback signals can be leveraged to alter the functions performed by the planner/orchestrator in routing questions to an appropriate question-answering model, or improve the manner in which a question-answering model generates an answer to a question. Improving the accuracy of question-answering models advantageously improves the functioning of computing devices on which such models are being executed. In particular, utilizing the generated evaluation scores to generate better (e.g., more accurate) answers to future questions posed to question-answering models advantageously reduces consumption of processing resources of the computing devices applying those question-answering models. Additional benefits and advantages are described later in this disclosure.

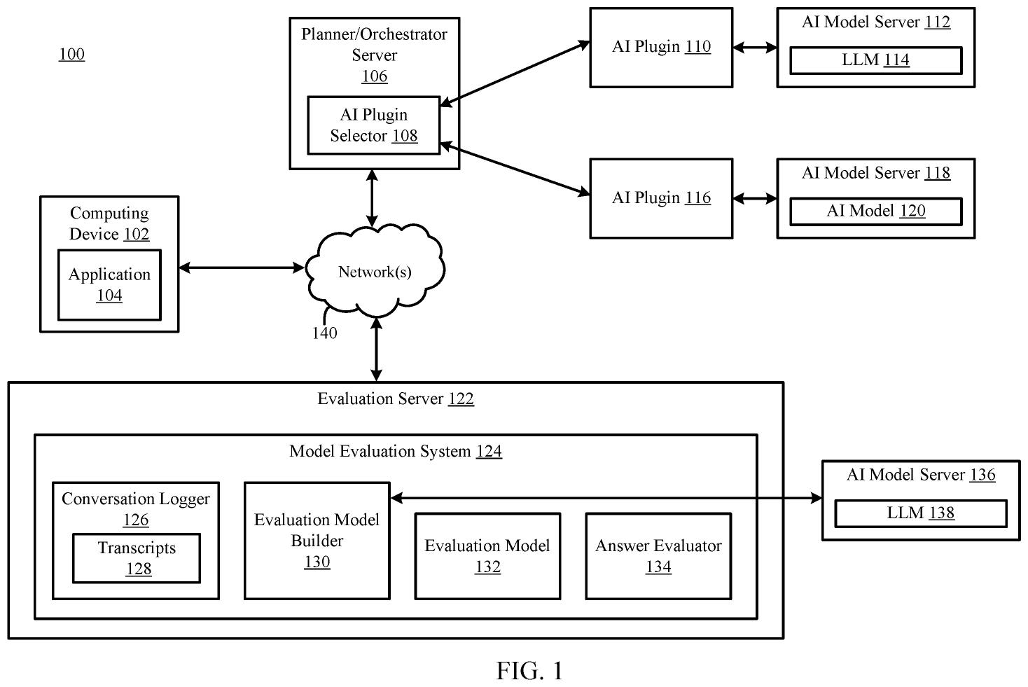

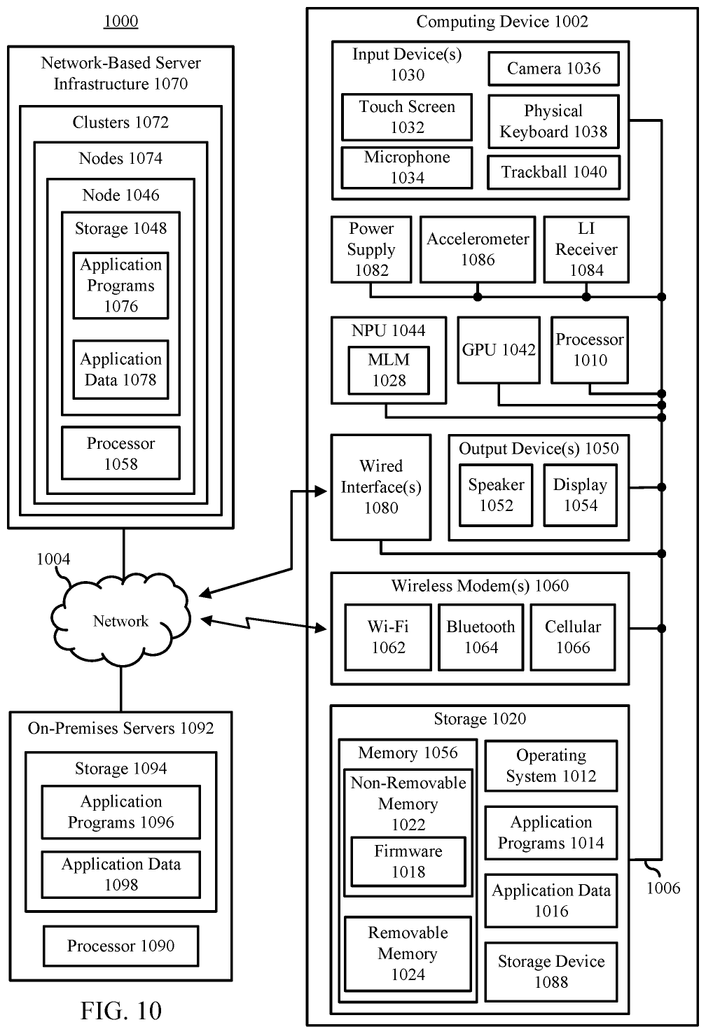

Embodiments for evaluating the performance of a question-answering model are implemented in various way. For instance, FIG. 1 shows a block diagram of system 100 for evaluating the performance of a question-answering model, in accordance with an example embodiment. As shown in FIG. 1, system 100 includes a computing device 102, a planner/orchestrator server 106, an artificial intelligence (AI) plugin 110, an AI model server 112, an AI plugin 116, an AI model server 118, an evaluation server 122, an AI model server 136, and a network 140. Computing device 102 includes an application 104. Planner/orchestrator server 106 includes an AI plugin selector 108. AI model server 112 includes an LLM 114. AI model server 118 includes an AI model 120. Evaluation server 122 includes a model evaluation system 124 that comprises a conversation logger 126, an evaluation model builder 130, an evaluation model 132, and an answer evaluator 134. Conversation logger 126 includes a collection of transcripts 128. AI model server 136 includes an LLM 138. An example device that incorporates the functionality of computing device 102, planner/orchestrator server 106, AI model server 112, AI model server 118, evaluation server 122, and/or AI model server 136 (or any subcomponents therein, whether or not illustrated in FIG. 1) is described below in reference to FIG. 10. It is noted that system 100 may comprise any number of devices, including those illustrated in FIG. 1 and optionally one or more further devices or components not expressly illustrated. System 100 is further described as follows.

In an example implementation, network 140 includes one or more of any of a local area network (LAN), a wide area network (WAN), a personal area network (PAN), a combination of communication networks, such as the Internet, and/or a virtual network. In example implementations, computing device 102, planner/orchestrator server 106, AI plugin 110, AI model server 112, AI plugin 116, AI model server 118, evaluation server 122, and/or AI model server 136 communicate via network 140. In an implementation, any one or more of computing device 102, planner/orchestrator server 106, AI plugin 110, AI model server 112, AI plugin 116, AI model server 118, evaluation server 122, and/or AI model server 136 communicate over network 140 via one or more application programming interfaces (API) and/or according to other interfaces and/or techniques. In an example, computing device 102, planner/orchestrator server 106, AI plugin 110, AI model server 112, AI plugin 116, AI model server 118, evaluation server 122, and/or AI model server 136 each include at least one network interface that enables communications with each other. Examples of such a network interface, wired or wireless, include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein.

In examples, computing device 102 comprises any one or more computing devices, servers, services, local processes, remote machines, web services, etc. for interacting with a question-answering model. In examples, computing device 102 is configured to execute application 104. In accordance with an embodiment, application 104 enables a user to interface with planner/orchestrator server 106 to obtain an answer to a question provided via application 104. In some other examples, application 104 enables a user to interface to AI model server 112 and/or AI model server 118 (e.g., without planner/orchestrator server 106). In examples, application 104 comprises a resource coupled to a network, including but not limited to computing or processing resources, software resources (e.g., software as a service (SaaS), platform as a service (PaaS), etc.), storage resources (e.g., physical storage devices, local storage devices, cloud-based storages, hard disk drives, solid state drives, random access memory (RAM) devices, etc.), databases, etc. in connection interacting with one or more question-answering systems. In some example embodiments, application 104 is accessible via a cloud.

In various embodiments, application 104 comprises a user interface that is configured to receive a question (also referred to herein as a query) to be answered. In some examples, the question is received in response to a user input. In various implementations, the question that is received is to be answered by one or more question-answering models, such as LLM 114, AI model 120, or any other model not expressly illustrated. In one example, the question that is received is provided to planner/orchestrator server 106, which routes the question to one or more models. In another example, the question that is received via application 104 is transmitted to one or more models without the aid of planner/orchestrator server 106. In yet some other examples, application 104 comprises features of planner/orchestrator server 106 such that application 104 selects an appropriate model to answer the received question, after which the question is provided (e.g., via an AI plugin) to the appropriate model server.

In some implementations, application 104 comprises an interface to configure and/or view information of evaluation server 122. For instance, application 104 comprises an interface that includes one or more user interactive controls (e.g., buttons, menus, alphanumeric input fields, icons, windows, etc.) to manage the operation and/or functionality of evaluation server 122, such as the manner in which an evaluation score is generated for an answer to a question. Additional details regarding the operation and/or functionality of application 104 will be described below

In examples, computing device 102 comprises any type of stationary or mobile computing device, including a mobile computer or mobile computing device (e.g., a Microsoft® Surface® device, a personal digital assistant (PDA), a laptop computer, a notebook computer, a tablet computer, a netbook, etc.), a desktop computer, a server, a mobile phone or handheld device (e.g., a cell phone, a smart phone, etc.), a wearable computing device (e.g., a head-mounted device including smart glasses, a smart watch, etc.), an Internet-of-Things (IoT) device, or other type of stationary or mobile device. Computing device 102 is not limited to a physical machine, but may include other types of machines or nodes, such as a virtual machine. In accordance with an embodiment, computing device 102 is associated with a user (e.g., an individual user, a group of users, an organization, a family user, a customer user, an employee user, an admin user (e.g., a service team user, a developer user, a management user, etc.), etc.). In an example, computing device 102 interfaces with other components illustrated in FIG. 1 through APIs and/or by other mechanisms.

Planner/orchestrator server 106, AI model server 112, AI model server 118, evaluation server 122, and AI model server 136 are network-accessible servers (or other types of computing devices). In accordance with an embodiment, one or more of model planner/orchestrator server 106, AI model server 112, AI model server 118, evaluation server 122, and AI model server 136 are incorporated in a network-accessible server set (e.g., a cloud-based environment, an enterprise network server set, and/or the like). Furthermore, as shown in FIG. 1, each of planner/orchestrator server 106, AI model server 112, AI model server 118, evaluation server 122, and AI model server 136 are a single server or computing device. Alternatively, any of planner/orchestrator server 106, AI model server 112, AI model server 118, evaluation server 122, and AI model server 136 are implemented across multiple servers or computing devices (e.g., as a distributed service) in various embodiments. Each of planner/orchestrator server 106, AI model server 112, AI model server 118, evaluation server 122, and AI model server 136 are configured to execute services and/or store data. For instance, as shown in FIG. 1, planner/orchestrator server 106 is configured to execute AI plugin selector 108, AI model server 112 is configured to execute LLM 114, AI model server 118 is configured to execute AI model 120, evaluation server 122 is configured to execute model evaluation system 124, and AI model server 136 is configured to execute LLM 138.

In various examples, planner/orchestrator server 106 is configured to receive a question (e.g., from application 104) to be answered by a question-answering model. In one example, planner/orchestrator server 106 provides the question, such as in a prompt, to one or more models (e.g., in an API call). In some embodiments, upon generation of the answer, the model returns the answer (e.g., in an API call response) to planner/orchestrator server 106, after which planner/orchestrator server 106 provides the answer to application 104. In another embodiment, the model returns the answer to application 104 (e.g., without the aid of planner/orchestrator server 106).

In one example embodiment, AI plugin selector 108 receives the question to be answered and selects an appropriate AI plugin to transmit to which the question is routed (e.g., directed). For instance, AI plugin selector 108 identifies which model(s) should be utilized for generating the answer to the question, and transmit the question to the identified model(s) for generating an answer. For example, if AI plugin selector 108 determines that the question relates to a particular domain or topic, AI plugin selector 108 selects an appropriate model that has a high (e.g., highest) likelihood of generating an accurate answer for questions relating to that particular domain or topic.

Thus, in various examples, a plurality of question-answering models are available to generate answers to questions. As shown in FIG. 1, AI plugin selector 108 is configured to select a first plugin (AI plugin 110) in order to cause LLM 114 to generate an answer to a received question and/or select a second plugin (AI plugin 116) to cause AI model 120 to generate an answer to the received question. AI plugin 110 and AI plugin 116 comprise interfaces by which planner/orchestrator server 106 communicates with LLM 114 and AI model 120 (e.g., via an API call or API call response), respectively, to generate an answer to a question.

The number and/or arrangement of AI plugins, model servers, and models is illustrative only. In various embodiments, any number of models are available to answer a given question via any suitable plugin. For instance, any number of AI or LLMs are employed, where each model is configured to answer certain types or categories of questions (e.g., based on the domain upon which the model was trained, the manner of training the model, the particular model technology implemented, etc.). In other words, in various examples, each plugin and/or associated model is specialized in some fashion to generate an answer to a given question. As used herein, a question-answering model refers to any such model used to generate an answer to a question.

AI plugin selector 108 selects the appropriate AI plugin for generating an answer to a question using various types of selection criteria. In one implementation, AI plugin selector performs an analysis on the received question (e.g., a semantic analysis, applying the question to a language model, etc.) to determine which AI plugin to transmit the question. In another implementation, AI plugin selector 108 selects the appropriate AI plugin based on a user input (e.g., via application 104). Thus, where questions presented via application 104 are free formed (e.g., in natural language) and therefore potentially diverse in subject matter, AI plugin selector 108 determines the most suitable AI plugin for each query in various examples. Such an arrangement allows for the utilization of multiple AI plugins and models, each specializing in its own way to generate an answer (e.g., based on domain-specific knowledge).

In accordance with disclosed techniques, evaluation of the performance of a model (e.g., LLM 114, AI model 120, or any other model not expressly illustrated) used to answer a user question received via application 104 can be based on each individual plugin. For instance, model evaluation system 124 generates evaluation model 132 (described in more detail below) for evaluating answers generated by LLM 114, while a separate evaluation model (not shown) is generated for evaluating answers generated by AI model 120. Thus, in examples, the disclosed techniques can be adapted and extended to any other AI plugins. Such an arrangement is only illustrative, however. It should be noted that in other embodiments, model evaluation system 124 is configured to generate an evaluation model 132 to evaluate answers generated by a plurality of question-answering models.

LLM 114, AI model 120, and LLM 138 each comprise any type of model that generates an output set of data (e.g., an answer) based on an input query (e.g., a question). In various examples, LLM 114 and AI model 120 comprise a generative AI model configured to generate a set of data based on a received prompt. In accordance with an embodiment, LLM 114 and LLM each comprise an LLM. In accordance with an embodiment, AI model 120 comprises a machine learning model configured to map an input to an output (e.g., using a neural network, a machine learning model, or the like). In some examples, AI model 120 comprises a model other than a generative AI model. In various examples, LLM 114, AI model 120, and LLM 138 are trained using public information (e.g., information collected and/or scrubbed from the Internet) and/or data stored by an administrator of their respective model servers. In accordance with an embodiment, LLM 114, AI model 120, and LLM 138 comprise “off the shelf” models trained to generate complex, coherent, and/or original content based on (e.g., any) prompt. In an alternative embodiment, LLM 114, AI model 120, and LLM 138 comprise specialized models trained to generate data parameters for a domain based on prompts. Additional details regarding the operation of the foregoing models are described elsewhere herein.

In examples, model evaluation system 124 is configured to evaluate a performance of LLM 114 and/or AI model 120 (or one or more other models, not expressly shown). As noted above, model evaluation system 124 is configured to be applicable for a given domain (e.g., a particular one of the foregoing models used to answer a user question) in some examples.

In an embodiment, conversation logger 126 is configured to store question and answer pairs generated by a question-answering model (e.g., one or more of LLM 114 or AI model 120). For instance, after a user question is transmitted to an appropriate model and an answer is generated thereto, the question and answer is combined into a tuple of information (e.g., a concatenation of the question and answer) and stored as a set of transcripts 128.

In accordance with an embodiment, evaluation model builder 130 is configured to build a training dataset by collecting user-question-answer pairs (e.g., from transcripts 128) and generate evaluation model 132. For example, evaluation model builder 130 is configured to collect an ample number of question-answer pairs (e.g., one or two hundred samples, though the number can be more or less) from the telemetry of the chat sessions stored in transcripts 128. The training dataset is then used, in part, as the training data to generate evaluation model 132.

In examples, evaluation model builder 130 is configured to provide each question-answer pair to LLM 138 to generate a score for the question-answer pair. The score generated by LLM 138 is indicative of a quality of the answer (e.g., where the answer is generated by LLM 114 or AI model 120) to the corresponding question. In examples, the score is generated by LLM 138 based on application of the LLM to the question-answer pair. In implementations, a score is generated for each question-answer pair in a similar manner, resulting in a set of data comprising questions, associated answers, and associated scores.

In examples, evaluation model builder 130 is configured to generate and/or train evaluation model 132 based on stored tuples that comprise the questions, answers, and scores. Evaluation model 132 serves as a surrogate model for evaluating question-answer pairs (e.g., to generate an evaluation score for a given question-answer pair). For instance, since evaluation model 132 is trained based on learning how LLM 138 generates scores when evaluating a question-answer pair, evaluation model 138 is applied to new question-answer pairs to generate an evaluation score in various embodiments.

For example, answer evaluator 134 is configured to receive a new question-answer pair, where the question-answer pair comprises a query (e.g., provided via application 104) sent to any question-answering model (e.g., LLM 114 or AI model 120) and the answer generated by the question-answering model. In embodiments, answer evaluator 134 applies evaluation model 132 to the new question-answer pair to generate a score for the question-answer pair, where the score is indicative of the quality of the answer in the pair to the question. In this manner, additional API calls need not be made to LLM 138 to evaluate the quality of a new answer to a new question. Rather, in accordance with an embodiment, evaluation model 132 is utilized instead.

In example embodiments, upon generating the score, answer evaluator 134 provides the score to application 104, thereby allowing a user to view the evaluation score along with the generated answer. In other embodiments, answer evaluator 134 provides the score to AI plugin selector 108, LLM 114, and/or AI model 120 to improve the performance of one or more aspects of the question-answering system. Additional details relating to the operation and functionality of model evaluation system 124 and/or other related components are described in further detail below.

Implementations are not limited to the illustrative arrangement shown in FIG. 1. For instance, any of the components shown in FIG. 1 are located in a same computing device, are co-located, or are located remote from each other. Furthermore, system 100 comprises any number of other devices, networks, servers, and/or computing devices coupled in any manner in various embodiments.

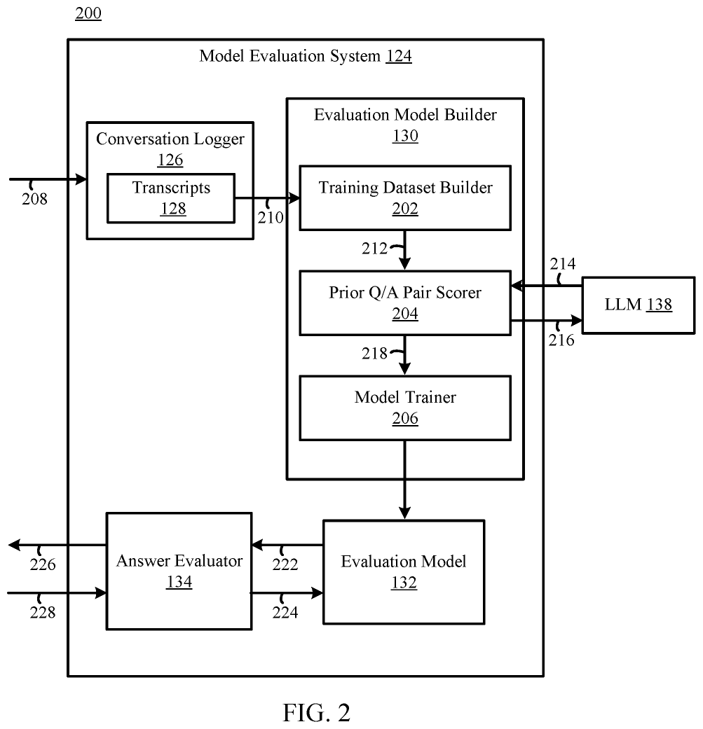

FIG. 2 depicts a block diagram of a system 200 for evaluating a question-answer pair, in accordance with an example embodiment. As shown in FIG. 2, system 200 includes an example implementation of model evaluation system 124 and an example implementation of LLM 138. Model evaluation system 124 includes an example implementation of conversation logger 126, an example implementation of evaluation model builder 130, an example implementation of evaluation model 132, and an example implementation of answer evaluator 134. Evaluation model builder 130 includes a training dataset builder 202, a prior question-answer (Q/A) pair scorer 204, and a model trainer 206.

In an embodiment, conversation logger 126 is configured to obtain each prior question and answer 208 generated thereto (referred to herein as a question-answer pair) as a set of transcripts 128. In accordance with an embodiment, the prior question and answer 208 comprises a question received by application 104 and provided to a question-answering model (e.g., LLM 114 or AI model 120), and an answer generated by the question-answering model. In examples, the question and answer 208 are received in a telemetry as each question and answer is generated. Conversation logger 128 is configured to store each question and answer as transcripts 128 to generate a set of prior (or historical) question-answer pairs that will be used, at least in part, as a training dataset, in various implementations. In some implementations, conversation logger 126 stores a subset of such prior question-answer pairs (e.g., based on a diversity of questions and/or answers, as described below).

Transcripts 128 comprise the history or log of prior question-answer pairs in any suitable data structure, such as in a listing, a table, a database, spreadsheet, document, etc. In one non-limiting illustration, the question-answer pairs are stored in a format (q, a), where q represents user questions filtered by the planner/orchestrator for transmission to a particular model, and a represents the answer generated by that model. In examples, conversation logger 126 combines these tuples into a table [(q1, a1), (q2, a2), . . . ] that can be stored in a dedicated database or other data structure. In one implementation, conversation logger stores multiple answers per question, such as where the model generates a plurality of answers for a given question. In another implementation, conversation logger 128 stores an identification of the question-answering model that generated the answer, such that evaluation model builder 130 is configured to filter and/or select tuples based on an identity of a question-answering model.

In various embodiments, conversation logger 126 obtains the question-answer pairs based on a telemetry across a plurality of users. In this way, conversation logger 126 stores a wide variety and number of question-answer pairs from a history of prior conversations between users (e.g., application 104) and a question-answering model.

In accordance with an embodiment, training set builder 202 is configured to obtain a set of prior question-answer pairs 210 stored in transcripts 128 to build a training dataset. For example, the training dataset comprises a set of question-answer pairs that will be used to train evaluation model 132. In various embodiments, the training dataset comprises a subset of question-answer pairs stored in transcripts 128. For example, training dataset builder 202 is configured to filter the received question-answer pairs 210 using one or more filtering criteria to identify a suitable subset of data that should be used as training data. In one example, as will be described in greater detail below, training dataset builder 202 is configured to select question-answer pairs that are sufficiently diverse, such that the training dataset comprises question-answer pairs that are unique from each other.

In accordance with an embodiment, the training dataset is stored as a set of tuples 212, where the set of tuples comprise the question-answer pairs from transcripts 128 that are selected for training evaluation model 132. As noted above, the tuples in the training dataset are stored in any suitable fashion (e.g., in any type of data structure, such as a table or database).

In accordance with an embodiment, prior Q/A pair scorer 204 is configured to obtain tuples 212 that make up the training dataset, where each tuple comprises a question-answer pair, and provide each tuple in a prompt 216 to LLM 138. In examples, the prompt is generated based on populating a template that comprises a generic quality evaluation (QE) prompt. In one example, the generic QE prompt comprises one or more fields in which the question-answer pair is to be inserted, and a string (e.g., a question or a statement) that requests a score from LLM 138 indicative of the quality of an answer in a given question-answer pair to the question in the pair.

Thus, in examples, prior Q/A pair scorer 204 is configured to provide each question-answer pair (e.g., by providing the tuple in a generic QE prompt) to LLM 138 to evaluate the tuple (e.g., an evaluation based on the quality of the answer to the question). In one example, the QE prompt requests a score (e.g., a rating on a scale from 1 to 10, or any other range, where 0 signifies an irrelevant answer, and 10 signifies a perfect relevance) indicative of the quality of the answer to the question in a given question-answer pair. For each tuple in the training dataset, LLM 138 is applied to the tuple to generate a corresponding score indicative of the quality of the answer to the question, as judged by LLM 138. The generated score 214 for a Q/A pair is received by prior Q/A pair scorer 204.

It should be noted that a plurality of LLMs are used in some implementations, as will be described in greater detail below. For instance, a mixture of LLM judges are implemented for each question-answer pair to obtain a plurality of scores, and such scores are combined (e.g., averaged) to generate a single combined score corresponding to the question-answer pair.

Upon obtaining score 214 (or generating a combined score in some implementations) for each tuple, a new tuple is created that comprises the question, associated answer, and score (e.g., in an illustrative format (q, a, <s>, where <s>is the score generated by LLM 138). In embodiments, such a process is extended to each tuple in the training dataset to generate a table (or other data structure) that identifies scores for each question-answer pair (e.g., in the format (q1, a1, <s1>), (q2, a2, <s2>), . . . ). In various embodiments, the new tuples are created by appending the scores to tuples 212, by creating a new set of tuples that comprise questions, answers, and scores, or in any other manner as appreciated by those skilled in the art. Collectively, the new tuples 218 (questions, answers, and scores) form the basis of the training data utilized by model trainer 206, as described further below.

Model trainer 206 is configured to obtain training data that comprises the tuples 218 containing questions, answers, and scores (as evaluated by LLM 138). Model trainer generates and/or trains evaluation model 132 based on a set of training data 218. In examples, the set of training data 218 comprises a set of features and a set of associated labels (e.g., ground truth annotations). In accordance with an embodiment, the features comprise information based on the question-answer pairs in tuples 218, and the labels comprise the scores associated with each question-answer pair in tuples 218. For instance, for a given tuple (q1, a1, <s1>), the features comprise information based on the question-answer pair q2, a2, and the label comprises the score <s2>associated with the question-answer pair.

The features are provided in any suitable format, such as in a multi-dimensional vector (e.g., an embedding) generated by applying one or more natural language processing (NLP) models or other language models to a question and/or answer. In one example, the features are provided to a concatenation of a question-answer pair (e.g., as a combined string). In another example, a plurality of features are provided for a given question-answer pair, such as a first feature generated from a question of the pair and a second feature generated from an answer of the pair. In some further implementations, a plurality of features associated with the questions and/or answers are generated and used for training evaluation model 132 (e.g., a first set of features based on a plurality of feature-generating algorithms for each question, and a second set of features based on a plurality of feature-generating algorithms for each answer). Other methods for generating features based on the question-answer pairs are also contemplated, as should be appreciated by those skilled in the relevant arts.

In examples, evaluation model builder 130 trains evaluation model 132 using a supervised learning algorithm. As discussed above, evaluation model builder 130 is configured to train evaluation model 132 using the question-answer pairs (q, a) as features and the scores <s>as labels in an embodiment. In one embodiment, evaluation model 132 is a regression machine learning (ML) model that is configured to act as a surrogate model for generating evaluation scores for a question-answer pairs. In examples, evaluation model 132 is implemented in various ways, such as a model that comprises a tree (e.g., boosted trees or the like), a neural network, etc. In this manner, model trainer 206 generates evaluation model 132 based on how LLM 138 generates scores when evaluating a question-answer pair, thereby allowing evaluation model to generate evaluation scores (e.g., without the use of LLM 138).

For instance, answer evaluator 134 is configured to obtain a current question-answer pair 228 (e.g., a new question-answer pair, where the answer was generated by one of the question-answering models LLM 114 or AI model 120) to evaluate the quality thereof. In examples, the new (or current) question-answer pair comprises a question-answer pair that is not part of the training dataset used to train evaluation model 132. In one implementation, question-answer pair 228 is received from any one or more of the components illustrated in FIG. 1, such as via planner/orchestrator server 106, AI plugin 110, AI plugin 116, AI model server 112, or AI model server 118, depending on the implementation of the question-answering system in a given environment. In another implementation, answer evaluator 134 receives question-answer pair 228 from application 104 (e.g., after the answer is provided to application 104 from the question-answering system), either automatically or in response to a user input to evaluate the quality of the received answer.

In examples, answer evaluator 134 provides data 224 based on the current question answer pair (e.g., a tuple containing the new question and answer) to evaluation model 132 such that evaluation model 132 is applied to the current question-answer pair to produce an evaluation score quantifying the quality of the current answer to the current question. In one example, data 224 is provided as one or more features based on the tuple (e.g., as embeddings or other vectors generated in a similar manner as described elsewhere herein, such as by concatenating the question and answer and/or applying the question and/or answer to a language model). In accordance with embodiments described herein, answer evaluator 134 utilizes the surrogate evaluation model (evaluation model 132) to generate the score, rather than LLM 138, thereby reducing utilized compute resources and reducing the overall cost.

In embodiments, evaluation model 132 returns data 222 to answer evaluator 134 comprising the score corresponding to the data 224. In examples, the score comprises a value (e.g., a numerical value, a letter value, a grade, etc.) between a minimum and maximum value, where the minimum value indicates that the answer has no relevance to the question and the maximum value indicates that the answer has complete relevance to the question. In some examples, the relevance, as that term is used herein, is indicative of the quality of the answer to the question.

As discussed earlier, evaluation model 132 is generated for a particular AI plugin and/or question-answering model (e.g., a particular domain), such that answers generated by that particular question-answering model are evaluated by evaluation model 132 specific to that question-answering model. In other words, evaluation model 132 is generated for a particular domain in some implementations, which allows evaluation model 132 to be more accurate in terms of generating evaluation scores. In some implementation, however, it should be understood that evaluation model 132 is generated to evaluate questions from a plurality of domains and/or question-answering models.

In various examples, answer evaluator provides the score 226 generated by evaluation model 132 to one or more endpoints, such as application 104, planner/orchestrator server 106, AI plugin selector 108, AI plugin 110, AI model server 112, AI plugin 116, and/or AI model server 118. In accordance with an embodiment, any one or more of the foregoing components performs one or more actions upon obtaining the generated score for a given question-answer pair, as described elsewhere herein.

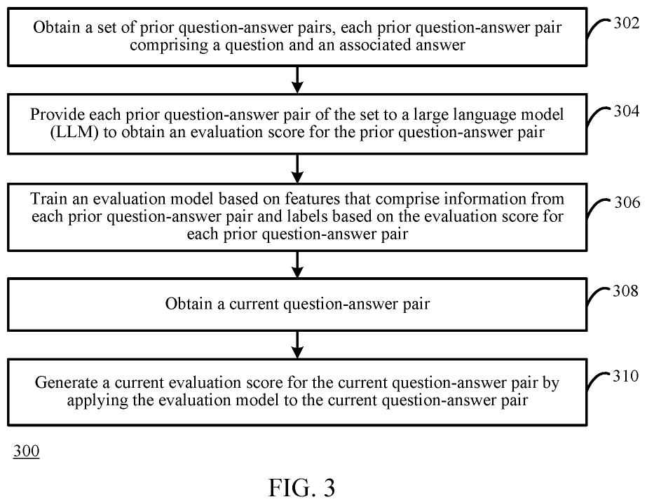

In accordance with one or more embodiments, the quality of question-answering systems is evaluated using a surrogate evaluation model. For example, FIG. 3 shows a flowchart 300 of a method for evaluating the performance of a question-answering model, in accordance with an example embodiment. In an embodiment, flowchart 300 is implemented by system 100 as shown in FIG. 1 and/or system 200 as shown in FIG. 2. Accordingly, flowchart 300 will be described with reference to FIGS. 1 and 2. Other structural and operational embodiments will be apparent to persons skilled in the relevant art(s) based on the following discussion regarding flowchart 300, system 100 of FIG. 1 and system 200 of FIG. 2.

Flowchart 300 begins with step 302. In step 302, a set of prior question-answer pairs is obtained, where each prior question-answer pair comprises a question and an associated answer. For instance, with reference to FIG. 2, prior Q/A pair scorer 204 is configured to receive tuples 212 that comprise a set of prior question-answer pairs. In examples, the prior question-answer pairs comprise past questions and answers (e.g., obtained from a chat history telemetry), where the questions are provided to a question-answering model (e.g., one of LLM 114, AI model 120, or another model not expressly illustrated), and the answer is generated by the question-answering model. In example embodiments, each question-answer pair comprises the text of the question presented to the question-answering model, as well as the associated answer (i.e., the answer generated by the question-answering model to the question).

In accordance with an embodiment, the set of prior question-answer pairs includes any number of prior question-answer pairs. In one implementation, the set of prior question-answer pairs are specific to a particular question-answering model (e.g., such that the set of question-answer pairs are related or associated with a particular domain). In another implementation, the set of prior question-answer pairs relate to a plurality of question-answering models. In various examples, the prior question-answer pairs are stored in transcripts 128 and/or filtered by training dataset builder 202, as described herein.

In step 304, each prior question-answer pair of the set is provided to a large language model to obtain an evaluation score for the prior question-answer pair. For instance, with reference to FIG. 2, prior Q/A pair scorer 204 is configured to provide one or more prompts 216 to LLM 138 (e.g., as an API call) to obtain an evaluation score 214 for each prior question-answer pair (e.g., as an API call response). In examples, a prompt provided to LLM 138 includes the question-answer pair (e.g., the text thereof) in any suitable structure and/or format. In embodiments, the prompt includes a query to LLM 138 requesting an evaluation score indicative of the quality of the answer in a given question-answer pair to the question of the same pair.

In response to receiving prompt 216, LLM 138 generates evaluation score 214 and returns the score to prior Q/A pair scorer 204. In examples, prior Q/A pair scorer 204 provides each question-answer pair to LLM 138 to generate an evaluation score for each pair. In this manner, prior Q/A pair scorer 204 is configured to generate a set of prior question-answer pairs and associated evaluation scores (e.g., where the foregoing is stored as a tuple of information in a suitable data structure, such as a table or database).

In step 306, an evaluation model is trained based on features that comprise information from each prior question-answer pair and labels based on the evaluation score for each prior question-answer pair. For instance, with reference to FIG. 2, model trainer 206 is configured to train evaluation model 132 based on features (e.g., vectors) that comprise information from each prior question-answer pair, and labels based on the evaluation score for each prior question-answer pair. In examples, evaluation model 132 is trained using a supervised learning algorithm and includes any one or more types of machine-learning models. In some implementations, the training is performed offline (i.e., prior to evaluating scores for unseen question-answer pairs as described below).

In accordance with an embodiment, since evaluation model 132 is trained based on prior question-answer pairs and associated evaluation scores (e.g., as determined by LLM 138), evaluation model 132 is configured to generate or predict (e.g., in an inference mode) a score for a previously unseen question-answer pair, where the predicted score indicates a quality of an answer to a question in a given question-answer pair. In an embodiment, evaluation model 132 is configured to predict the score that an LLM (such as LLM 138) would generate for a question-answer pair. In other words, evaluation model 132 is configured to mimic the performance of LLM 138 with respect to generation of evaluation scores.

In step 308, a current question-answer pair is obtained. For instance, with reference to FIG. 2, answer evaluator 134 obtains a current question-answer pair 228. In examples, current question-answer pair 228 comprises a question provided to a question-answering model, and an answer generated by the question-answering model. In various embodiments, the current question-answer pair comprises a question and answer for which an evaluation score has not yet been generated. For instance, the current question-answer pair comprises a question and answer that is not part of the training dataset used to train evaluation model 132.

In some embodiments, the current question-answer pair is obtained in real-time or near real-time with the generation of the answer by a question-answering model. In some embodiments, answer evaluator 134 obtains the question-answer pair 134 prior to the answer of the question-answer pair being provided to application 104. In this manner, the answer of the pair is provided to application 104 concurrently with the evaluation score (e.g., for concurrent or simultaneous presentation in application 104). In other examples, the answer is provided to application 104 in parallel with answer evaluator 134 obtaining the question-answer pair, such that an associated evaluation score is provided to application 104 following presentation of the answer in application 104.

In step 310, a current evaluation score is generated for the current question-answer pair by applying the evaluation model to the current question-answer pair. For instance, with reference to FIG. 2, answer evaluator is configured to apply evaluation model 132 (e.g., in an inference mode) to the current question-answer pair to generate a current evaluation score for the question-answer pair. Accordingly, in implementations, answer evaluator 134 need not rely on any additional calls to LLM 138 to generate the evaluation score, but instead utilizes evaluation model 132 that acts as a surrogate model for generating evaluation scores. In various examples, the generated score is transmitted to one or more endpoints, such as application 104.

An illustration of certain aspects of the foregoing process is described as follows. For instance, a current query (e.g., previously unseen) is received by application 104, where the question is to be answered by a generative model or other question-answering model. The question is received by planner/orchestrator server 106, after which AI plugin selector 108 selects a particular AI plugin and/or question-answering model to generate an answer for the query. In an illustrative illustration, AI plugin selector 108 selects AI plugin 110 corresponding to LLM 114 to generate an answer to the question. The question is transmitted by planner/orchestrator server 106 to AI plugin 110, and LLM 114 subsequently generates an answer to the question. In accordance with an embodiment, answer evaluator 134 obtains the question and answer (as generated by LLM 114), and applies evaluation model 132 to the question and answer to generate an evaluation score. The score is returned to application 104, enabling a user thereof to perform one or more actions based on the score.

In various embodiments, other types of actions are performed in response to generating an evaluation score for a current question-answer pair. In some implementations, an indication based on score 226 is provided (e.g., as a feedback signal) to one or more other entities to improve the performance of a question-answering system. As used herein, a question-answering system comprises any one or more components of a system that receives a question (e.g., via application 104) and coordinates and/or generates the answer to the question. For instance, an indication is provided to planner/orchestrator server 106, AI plugin 110, AI model server 112, AI plugin 116, and/or AI model server 118 (or any subcomponents thereof). In examples, the indication relates to a quality of the current answer to a current question. In some implementations, the indication comprises score 226. In response, any of the foregoing components change a functionality thereof based on the score in accordance with example embodiments.

For example, AI plugin selector 108 obtains the evaluation score and improves the routing of future questions to appropriate plugins, such as by selecting a different plugin that is likely to result in a higher evaluation score. In another example, AI plugin selector 108 obtains the evaluation score for a given question-answer pair and determines that the evaluation score is below a threshold. In examples, such a situation can occur where a question is provided to an incorrect plugin, such as where the question relates to a first domain, but a plugin corresponding to a second domain is selected to generate the answer to the question. In such a situation, AI plugin selector 108 routes the question of the same question-answer pair to a different AI plugin (e.g., by relying on a different model to generate a different answer to the same question). A score associated with the different answer is generated/obtained in a similar fashion (e.g., by model evaluation system 124), and planner/orchestrator server 106 provides the answer with the highest score to application 104 (along with the score, in some implementations). Since model evaluation system 122 need not make any additional LLM API calls to generate a new score for the different answer (and instead relies upon evaluation model 132 which is a regression model in example embodiments), the new score is able to be generated with reduced latency, costs, and processing power, thus enabling multiple answers to the same question to be generated and evaluated. Thus, the operation of planner/orchestrator server 106 is improved in various implementations. These examples are only illustrative, and other improvements to the planner/orchestrator are also possible based on the generated score.

In another example, the AI plugin (or AI model server) obtains the evaluation score for a given question-answer pair and determines that one or more models needs to be retrained and/or reconfigured due to evaluation scores being low (e.g., under a threshold). In another example, the AI plugin (or AI model server) determines that the models should be split into multiple domains because questions from a certain domain are being answered with low scores. In response, one or more additional domains are implemented (e.g., by adding one or more additional LLM or AI models) to generate answers to questions. Thus, the functionality of these additional components of the question-answering system are also improved in examples.

In another implementation, AI plugin selector 108 selects a plurality of AI plugins to generate an answer to a question provided via application 104, and model evaluation system 124 generates a score for each such answer (e.g., where each answer is generated by a different question-answering model). In such an example, the answer with the highest score is returned to application 104 (e.g., by planner/orchestrator server 106 or via one or more other components of a question-answering system). In this manner, the question-answering system overall is improved. The foregoing examples are only illustrative, and other improvements to various components of the question-answering system are also possible based on model evaluation system 124.

In accordance with the disclosed techniques, automation of the evaluation of an answer generated by a question-answering system is achieved. Such techniques allows for a more scalable and cost-effective approach to assessing the performance of generative question-answering systems compared to other approaches. This not only enhances the efficiency of AI services in general, but also allows for enhancements across various AI plugins and domains within an overarching AI system.

In examples, various advantages are possible. For instance, the number of LLM API calls is bounded and/or fixed, compared to other techniques in which LLM API calls grow linearly with each additional answer to be evaluated. For instance, once the surrogate model is trained, LLM API calls not needed in various embodiments. Instead, each new question-answer pair is by inputting the question-answer pair to the surrogate model (evaluation model 132), which in some implementations is trained based on a mixture of judges. In this manner, the surrogate model learns from the one or more LLM judges, where the surrogate model is then used without further costly LLM API calls (e.g., for free).

Accordingly, by reducing the reliance on LLMs to evaluate new queries, API calls (which is often a primary expense in question-answering system) can be reduced. Rather, such calls are limited to the training phase in various examples, and is bounded. In addition, the disclosed techniques are more compared to other techniques, such as where relevance information is gathered from human domain experts. In addition, human labeling of a training dataset is not needed in accordance with disclosed embodiments, which serves to streamline the training process and mitigates potential biases introduced by human subjectivity, enhancing the objectivity and reliability of the surrogate model.

In another example, as described in further detail below, a mixture of judges is implemented during the training phase of the surrogate model. This allows for minimizing biases where the same LLM model (or family of models) that generated the answer is used to evaluate the quality of the answer (e.g., as a result of the training datasets that those LLMs were trained on). By introducing a mixture of judges based on multiple LLMs, the different evaluation scores are combined together into a unified score that is better representative of the task of evaluating an answer in various applications.

In yet another example, the surrogate model that is trained is tailored to a specific domain of queries directed by the planner/orchestrator to a designated AI plugin in some implementations. This domain-specific focus enhances the trustworthiness of the relevance score when compared to other approaches that utilize a general-purpose approach to evaluating answers (e.g., approaches that are not domain-specific).

In yet another example, the disclosed techniques are implementable and/or integrated into existing question-answering systems without undue engineering effort. In this way, compatibility with an established infrastructure can be maintained without requiring substantial system modifications.

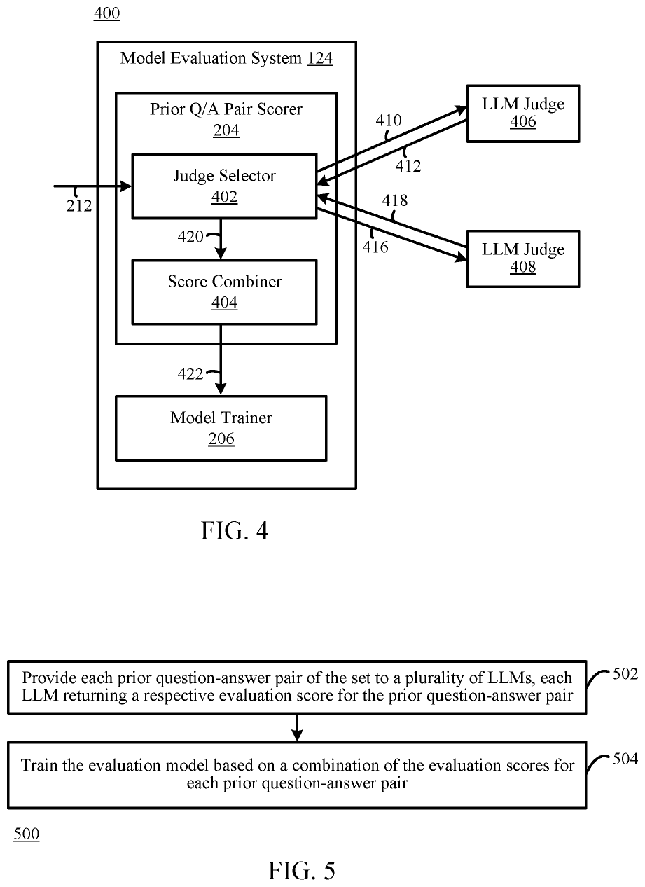

As described above, model evaluation system 124 utilizes a plurality of LLMs to generate a plurality of scores for a given prior question-answer pair in some implementations. For example, FIG. 4 shows a block diagram of a system 400 for scoring a question-answer pair using multiple judges, in accordance with an example embodiment. System 400 comprises an example implementation of model evaluation system 124, an LLM judge 406, and an LLM judge 408. Model evaluation system 124 comprises an example implementation of prior Q/A scorer 204 and model trainer 206. As shown in FIG. 4, prior Q/A scorer 204 comprises a judge selector 402 and a score combiner 404.

In accordance with an embodiment, judge selector 402 is configured to obtain tuples 212 that make up the training dataset, where each tuple comprises a prior question-answer pair. In examples, judge selector 402 selects a plurality of different (e.g., distinct) judges to evaluate the prior question-answer pair, where each judge comprises a different implementation of a model. In examples, judge selector 402 selects a first LLM judge 406 and a second LLM judge 408 to generate a score for the question-answer pair, in a similar fashion as described above. For instance, judge selector 402 provides the question-answer pair in a prompt 410 to LLM judge 406 and obtains a score 412 from LLM judge 406 in response. Similarly, judge selector 402 provides the same question-answer pair in a prompt 416 to LLM judge 408 and obtains a score 418 from LLM judge 408 in response. In this manner, multiple evaluation scores are obtained for each prior question-answer pair in the training dataset.

In examples, LLM judge 406 and LLM judge 408 are examples of LLM 138. However, LLM judge 406 and LLM judge 408 are implemented differently from each other (e.g., via different training datasets, different model technologies, different generative AI systems, etc.). In implementations, each LLM judge comprises an LLM, such as an external and/or pre-trained model.

It should be understood that while system 400 illustrates only two LLM judges (LLM judge 406 and LLM judge 408), any number of judges (LLM and/or other types of models) are possible, where judge selector 402 selects any number of the judges for generating evaluation scores. For instance, judge selector 402 is configured to provide a prompt to five, ten, or even more judges and obtain a score from each judge corresponding to each prior question-answer pair.

In some implementations, the set of judges (LLM judge 406 and LLM judge 408 in this illustration) includes at least one model that is different from the model used to generate the answer to the question in the prior question answer pair. For instance, if LLM 114 generated the answer to a particular question of a prior question-answer pair, judge selector 402 is configured to select at least one judge that implements a different model than LLM 114. In examples, the different LLM comprises an LLM trained using a different dataset, an LLM that implements a different generative AI algorithm, or any other type of different model such that at least one judge used to generate the score is not biased.

Thus, in various examples, system 400 implements a diverse list of models that form a mixture of judges (MoJ) denoted as {LLM₁, LLM₂, . . . }, where the MoJ comprises at least some distinctiveness from the model(s) used by the AI plugin(s) for generating an answer of a question-answer pair. In various examples, the number of judges utilizes are selected such that a statistically significant set of results is obtained. In examples, the judges can be in the same domain as the AI plugin, a different domain, or encompass a plurality of domains.

Each prior question-answer pair in the set of tuples 212 is scored in a similar fashion as described above, resulting in a set of scores for each prior question-answer pair. For instance, for each tuple in the training telemetry, a prompt (e.g., a populated generic prompt) is applied to each MoJ judge, producing a plurality of relevancy scores for each tuple, resulting in collection of scores 420. Such scores are stored in a suitable data structure, such as a database or a table. In one illustration, the scores are stored as (q1, a1,<s1ₐ>, <s1_{b}>, . . . <s1ₘ>,), where m indicates the number of judges used in the MoJ set.

In examples, score combiner 404 the collection of scores 420 and combines the scores corresponding to each question-answer pair. In implementations, score combiner 404 combines the scores for a given question-answer pair in any one or more ways, such as by aggregating the scores, averaging the scores, averaging the scores with a weighted average (e.g., by weighting a given model judge, such as a judge that is of the same family or domain as the model used to generate the answer, different from one or more other model judges). In this manner, score combiner 404 produces relevancy scores that are combined to create a new tuple (q, a, <s>), where q represents a question, a represents an answer to the question, and <s>represents the combined score for the question-answer pair. In examples, score combiner 404 extends this process to all of the tuples in the training telemetry database, resulting in a new set of tuples 8 stored in a data structure (e.g., a table, database, etc.) that contains the prior question of a question-answer pair, the prior answer of the question-answer pair, and a combined score associated with the question answer pair. In an illustration, the tuples are stored as [(q1, a1, <s1>), (q2, a2, <s2>), . . . ]. In the pseudo-code described below, this is denoted as processed_training_data.

In accordance with an embodiment, model trainer 206 obtains the set of tuples 422 to train evaluation model 132 in a similar manner as described above. For instance, since the scores in the tuples represent combined scores from a mixture of judges, evaluation model 132 thereby is trained based on a mixture of different judges as well. In the pseudo-code described below, the evaluation model is denoted as surrogate_model.

It should be noted, however, that as an alternative to a single evaluation model (e.g., evaluation model 132), a plurality of evaluation models are possible in some embodiments, where each evaluation model is based on a particular judge. For instance, if the MoJ set comprised seven judges, model trainer 206 obtains tuples 420 (i.e., containing the uncombined scores) to generate seven evaluation models, thereby allowing the generation of seven scores when the evaluation model is used in an inference mode by answer evaluator 134. In such a situation, each of the seven scores could be provided to a user, or a combination of scores (e.g., an aggregate, average, etc.) could be provided.

An illustrative pseudo-algorithm is shown below that describes an illustrative technique for a generative question-answering system evaluation method with mixed judges:

### Input:

telemetry_database={[(q₁, a₁), (q₂, a₂) . . . (qₙ, aₙ)}//training dataset of question-answer pairs
mixture_of_judges={LLM₁, LLM₂ . . . LLMₘ}//diverse set of pre-trained LLMs generic qeprompt “Given (q, a), please give me a rating on a scale of 0 to 10with 0 being that a is completely irrelevant with respect to q and 10 being that a is perfectly relevant”//example prompt template

### Output:

QAS=(q, a, relevance_score)//tuple of query, answer, and average relevance scores (also referred to as evaluation scores)
   Procedure (Telemetry_Database, Mixture_of_Judges, Generic_qe_Prompt, new_Query, ai_Plugin):

| | |
|---|---|
| 1: | for each tuple_qa ∈telemetry_database do |
| 2: | processed_training_data ← apply_qe_prompt |
| 3: | (tuple_qa, mixture_of_judges, generic_qe_prompt) |
| 4: | //apply the generic QE prompt to all tuples in the telemetry database |
| 5: | using all judges in MoJ |
| 6: | end for |
| 7: | surrogate_model ← train_surrogate_model (processed_training_data) |
| 8: | // train a supervised surrogate regression ML model |
| 9: | // This marks the end of the training phase. The inference phase is as |

follows for evaluating a question-answer pair.

| | |
|---|---|
| 10: | tuple_qa ←create_tuple_for_inference (new_query, |
| 11: | ai_plugin.generate_answer(new_query)) |
| 12: | relevance score ← surrogate_model.predict (tuple_qa) |
| 13: | return QAS |

end procedure

In the pseudo-code shown above, upon generation of the surrogate model using a mixture of judges (explained earlier in an accordance with an example embodiment), the surrogate model is utilized during an inference mode to generate a relevance score (or an evaluation score) for a current question-answer pair. For instance, the surrogate model is applied to assess the relevance of an AI plugin's answer to a new user query, yielding a quantified relevance score. For example, given a previously unseen user query q (also referred to as a new query or a current question), it is dispatched by the planner/orchestrator to an appropriate AI plugin as described earlier to generate an answer a. In the pseudo-code above, the process of generating an answer a from a query q using an AI plugin is denoted as a←ai_plugin.generate_answer(new_query). The surrogate evaluation model is then applied to the tuple (q, a), which produces a relevance score s that quantifies the answer's quality concerning the given question.

It should be understood that while the pseudo-algorithm below utilizes a mixture of judges, the algorithm could also be applied in other scenarios in a similar fashion where only a single judge is utilized.

As described above, a mixture of judges is used in various examples to train an evaluation model. For example, FIG. 5 shows a flowchart 500 for generating an evaluation model using a plurality of judges, in accordance with an example embodiment. In an embodiment, flowchart 500 is implemented by system 100 as shown in FIG. 1, system 200 as shown in FIG. 2, and/or system 400 as shown in FIG. 4. Accordingly, flowchart 500 will be described with reference to FIGS. 1, 2, and 4. Other structural and operational embodiments will be apparent to persons skilled in the relevant art(s) based on the following discussion regarding flowchart 500, system 100 of FIG. 1, system 200 of FIG. 2, and system 400 of FIG. 4.

Flowchart 500 begins with step 502. In step 502, each prior question-answer pair of a set is provided to a plurality of LLMs, each LLM returning a respective evaluation score for the prior question-answer pair. For instance, with reference to FIG. 4, judge selector 402 is configured to obtain tuples 212 that comprise a set of prior question-answer pairs. In accordance with an embodiment, judge selector 402 is configured to provide each question-answer pair in the set of question-answer pairs to LLM judge 406 and LLM judge 408 (and/or any additional judges not expressly shown). In examples, LLM judge 406 and LLM judge 408 (and/or any additional judges not expressly shown) return an evaluation score for the question-answer pair, resulting in a plurality of evaluation scores (each generated by a different judge) for a given question-answer pair.

In step 504, an evaluation model is trained based on a combination of the evaluation scores for each prior question-answer pair. For instance, model trainer 206 is configured to obtain tuples 422 that comprise combined scores for each question-answer pair, and train evaluation model 132 based thereon.

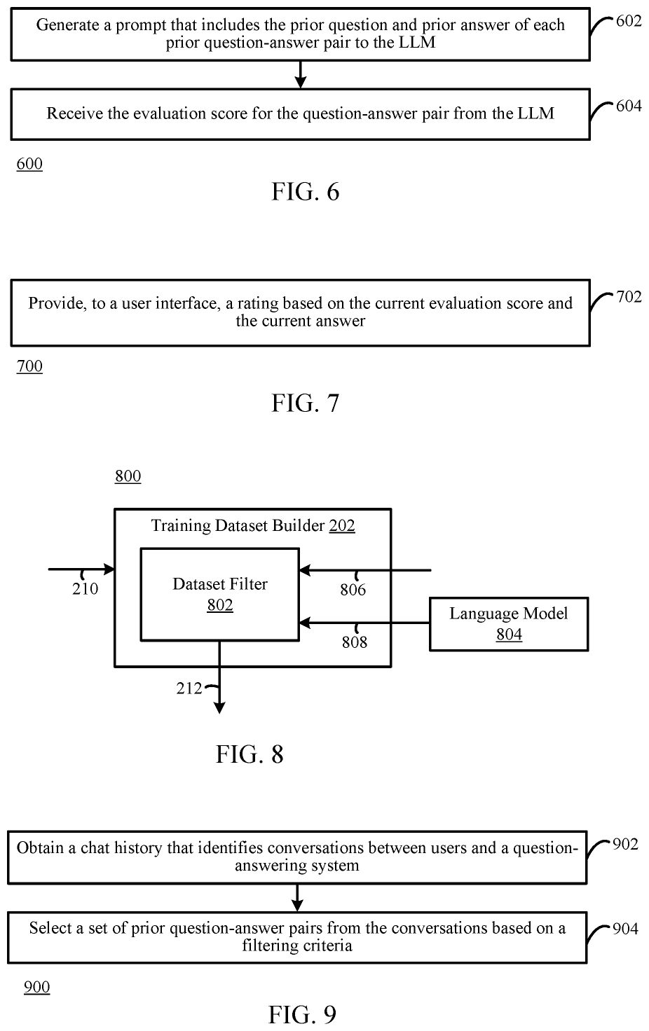

As described above, a prompt is provided to an LLM to obtain an evaluation score for a prior question-answer pair. For example, FIG. 6 shows a flowchart 600 of a method for receiving an evaluation score in response to generating a prompt for an LLM, in accordance with an example embodiment. In an embodiment, flowchart 600 is implemented by system 100 as shown in FIG. 1 and/or system 200 as shown in FIG. 2. Accordingly, flowchart 600 will be described with reference to FIGS. 1 and 2. Other structural and operational embodiments will be apparent to persons skilled in the relevant art(s) based on the following discussion regarding flowchart 600, system 100 of FIG. 1, and system 200 of FIG. 2.

Flowchart 600 begins with step 602. In step 602, a prompt that includes the prior question and prior answer of each prior question-answer pair is generated for providing to an LLM. For instance, with reference to FIG. 2, prior Q/A pair scorer 204 is configured to generate a prompt to LLM 138 (or a plurality of LLM judges, as illustrated in FIG. 4) that includes a prior question and a prior answer, where the prior question and answer are obtained from a telemetry of prior questions and answers (e.g., as part of a training dataset) generated by one or more question-answering models.

In examples, the prompt comprises a generic prompt that is populated with the prior question and prior answer to be evaluated by the LLM. In embodiments, the prompt also includes a question or query to the LLM to provide an evaluation score indicative of a quality of the answer to the question in the prompt. For instance, the generic prompt comprises one or more fields in which the question-answer pair is to be inserted, and a string (e.g., a question or a statement) that requests a score from the LLM indicative of the quality of an answer in a given question-answer pair to the question in the pair. In examples, the prompt also defines the criteria for scoring the question-answer pair by the LLM, such as by requesting a score based on a relevance or quality of the answer to the question. In some examples, the prompt also defines a range of values of the possible scores (which can be a number, grade, etc.). An example of a generic prompt in accordance with disclosed techniques is “Given (q, a), please give me a rating on a scale of 0 to 10 with 0 being that a is completely irrelevant with respect to q and 10 being that a is perfectly relevant,” where (q, a) is populated with the question-answer pair to be evaluated. In implementations, the prompt 216 is provided to LLM 138 for generating an evaluation score (e.g., as an API call to the LLM in an inference mode).

In step 604, the evaluation score for the question-answer pair is received from the LLM. For instance, with reference to FIG. 2, prior Q/A pair scorer 204 is configured to receive score 214 that comprises an evaluation score for the question-answer pair, where the score was generated by the LLM.

As described above, evaluation model 132 is configured to generate a score for a current question-answer pair to provide to various endpoints. For example, FIG. 7 shows a flowchart 700 of a method for providing a rating based on an evaluation score, in accordance with an example embodiment. In an embodiment, flowchart 700 is implemented by system 100 as shown in FIG. 1 and/or system 200 as shown in FIG. 2. Accordingly, flowchart 700 will be described with reference to FIGS. 1 and 2. Other structural and operational embodiments will be apparent to persons skilled in the relevant art(s) based on the following discussion regarding flowchart 700, system 100 of FIG. 1, and system 200 of FIG. 2.

Flowchart 700 begins with step 702. In step 702, a rating based on the current evaluation score and the current answer is provided to a user interface. For instance, with reference to FIGS. 1 and 2, a rating based on score 226 is provided to application 104. In examples, application 104 comprises a user interface in which a user inputs a question to be answered. The user interface also receives an answer (e.g., as generated by a question-answering model). In accordance with an embodiment, the user interface also provides a rating based on an evaluation score as disclosed herein. In examples, the rating comprises the score (e.g., a value between a predetermined range) and/or a measure based on the score (e.g., a grade, ranking, etc.). In one illustration, the ranking comprises a ranking category (e.g., indicating that the answer is a low quality, a medium quality, or high quality answer) from among a plurality of categories relating to a quality of the answer. Such ratings are only illustrative, and other types of ratings are also contemplated for providing to a user interface, where the rating is indicative of a quality of an answer to a question.

As described above, training dataset builder 202 is configured to filter transcripts 128 to generate a training dataset for training evaluation model 132. For example, FIG. 8 shows a block diagram of a system 800 for filtering a set of set of question-answer pairs, in accordance with an example embodiment. System 800 comprises an example implementation of training dataset builder 202 and a language model 804. Training dataset builder 202 comprises a dataset filter 802.

In examples, dataset filter 802 is configured to obtain prior question-answer pairs 210 stored in transcripts 128 to build a training dataset. Dataset filter 802 is configured to apply a filtering criteria to prior question-answer pairs in selecting a subset of prior question-answer pairs 210 to generate the training dataset stored as tuples 212. In an implementation, the filtering criteria defines which types and prior question-answer pairs should be selected for use in the training dataset. In one implementation, the filtering criteria specifies an amount of diversity (e.g., a sematic difference between question-answer pairs), such that the training dataset has question-answer pairs that are diverse in content.

In accordance with an embodiment, dataset filter 802 applies language model 804 to question-answer pairs to analyze the question-answer pairs. For example, language model 804 comprises one or more language models that is used to generate a vector 808 or other representation for a word or phrase. In some examples, language model 804 comprises an embedding model configured to generate an embedding. In examples, an embedding model comprise a deep-learning model that is configured to map a word or sequence of words to a numerical value, such as a multi-dimensional vector. In various implementations, the embedding model is trained based on an algorithm that utilizes language data that comprises the usage of words in a given language, such as books, academic literature, dictionaries, encyclopedias, data available on the Internet, newspapers, other language models, and/or any other language data. In some implementations, the embedding model is trained based on millions or billions of word or word combinations and comprise hundreds or even thousands of dimensions.

Furthermore, in various examples, language model 804 is trained using various types of learning techniques as will be appreciated to those skilled in the relevant arts, including but not limited to skip-gram, co-occurrence learning, negative sampling, etc. These examples are illustrative only and include other algorithms for training language model 804, including any other natural language processing (NLP) or natural language understanding (NLU) methods appreciated to those skilled in the relevant arts.

Language model 804 is generated in various forms. For instance, language model 804 is generated by applying a suitable supervised and/or unsupervised machine-learning algorithm. For example, language model 804 is generated by implementing a vector space learning algorithm to generate the embedding model as a vector space model. As a vector space model, language model 804 represents individual words or sequences of words in a continuous vector space (e.g., a multi-dimensional space), where similar words or sequences of words are mapped to nearby points or are embedded near each other. Furthermore, an artificial neural network learning algorithm is used in some implementations to generate and/or train language model 804 as a neural network that is an interconnected group of artificial neurons. The neural network is presented with word or sequence of words to identify a representation of the inputted word or sequences of words. Language model 804 could be implemented using any suitable neural network architecture. In examples, by applying language model 804, dataset filter 802 determines a semantic meaning of question-answer pairs, and selects question-answer pairs that are semantically different from each other (e.g., where the vectors corresponding to each question-answer pair have a difference beyond a threshold value). In some other implementations, dataset filter 802 applies language model 802 to identify two or more question-answer pairs that are semantically similar. In such a scenario, dataset filter 802 is configured to use only one of those question-answer pairs in the training dataset (e.g., by removing duplicates or near-duplicates from the training dataset). In this manner, training dataset comprises question-answer pairs that are diverse from each other.

As described above, a training dataset can comprise tuples that are filtered. For example, FIG. 9 shows a flowchart 900 of a method for applying a filtering criteria to a chat history, in accordance with an example embodiment. In an embodiment, flowchart 900 is implemented by system 900 as shown in FIG. 8. Accordingly, flowchart 900 will be described with reference to FIG. 8. Other structural and operational embodiments will be apparent to persons skilled in the relevant art(s) based on the following discussion regarding flowchart 900 and system 900 as shown in FIG. 8.

Flowchart 900 begins with step 902. In step 902, a chat history is obtained that identifies conversations between users and a question-answering system. For example, with reference to FIG. 8, dataset filter 802 obtains prior question-answer pairs 210 from transcripts 128 that identify conversations between users (e.g., users of application 104) and a question-answering system (e.g., planner/orchestrator server 106 and/or associated AI plugins and/or models).

In step 904, a set of prior question-answer pairs is selected from the conversations based on a filtering criteria. For instance, with continued reference to FIG. 8, dataset filter 802 applies filtering criteria 806 to select a set of prior question-answer pairs from the transcript history. In various embodiments, the filtering criteria comprises a diversity criteria that indicates an amount of diversity between question-answer pairs to use in the training dataset, as discussed above. In examples, such filtering allows for improved processing and/or storage, such as by reducing the overall number of question-answer pairs used during the training phase, where pair is evaluated by one or more LLMs to obtain scores, which are then stored (or combined in some instances to generate a combined score). In addition, ensuring that the training dataset comprises a diverse set of question-answer pairs enables the evaluation model to be trained in a more accurate manner, improving the overall performance of the evaluation model in generating relevance scores.

### III. Example Mobile Device and Computer System Implementation

Computing device 102, application 104, planner/orchestrator server 106, AI plugin selector 108, AI plugin 110, AI plugin 116, AI model server 112, LLM 114, AI model server 118, AI model 120, evaluation server 122, model evaluation system 124, conversation logger 126, evaluation model builder 130, evaluation model 132, answer evaluator 134, AI model server 136, LLM 138, training dataset builder 202, prior Q/A pair scorer 204, model trainer 206, judge selector 402, score combiner 404, LLM judge 406, LLM judge 408, dataset filter 802, and/or language model 804 are implemented in hardware, or hardware combined with one or both of software and/or firmware. For example, application 104, AI plugin selector 108, AI plugin 110, AI plugin 116, LLM 114, AI model 120, model evaluation system 124, conversation logger 126, evaluation model builder 130, evaluation model 132, answer evaluator 134, LLM 138, training dataset builder 202, prior Q/A pair scorer 204, model trainer 206, judge selector 402, score combiner 404, LLM judge 406, LLM judge 408, dataset filter 802, and/or language model 804, and/or the components described therein, and/or the steps of flowcharts 300, 500, 600, 700, and 900 are each implemented as computer program code/instructions configured to be executed in one or more processors and stored in a computer readable storage medium. Alternatively, computing device 102, application 104, planner/orchestrator server 106, AI plugin selector 108, AI plugin 110, AI plugin 116, AI model server 112, LLM 114, AI model server 118, AI model 120, evaluation server 122, model evaluation system 124, conversation logger 126, evaluation model builder 130, evaluation model 132, answer evaluator 134, AI model server 136, LLM 138, training dataset builder 202, prior Q/A pair scorer 204, model trainer 206, judge selector 402, score combiner 404, LLM judge 406, LLM judge 408, dataset filter 802, and/or language model 804, and/or the components described therein, and/or the steps of flowcharts 300, 500, 600, 700, and 900 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 10. FIG. 10 shows a block diagram of an exemplary computing environment 1000 that includes a computing device 1002. Computing device 1002 is an example of computing device 102, planner/orchestrator server 106, AI model server 112, AI model server 118, evaluation server 122, and AI model server 136, which each include one or more of the components of computing device 1002. In some embodiments, computing device 1002 is communicatively coupled with devices (not shown in FIG. 10) external to computing environment 1000 via network 1004. Network 1004 comprises one or more networks such as local area networks (LANs), wide area networks (WANs), enterprise networks, the Internet, etc. In examples, network 1004 includes one or more wired and/or wireless portions. In some examples, network 1004 additionally or alternatively includes a cellular network for cellular communications. Computing device 1002 is described in detail as follows.

Computing device 1002 can be any of a variety of types of computing devices. Examples of computing device 1002 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 1002 is a stationary computing device such as a desktop computer, a personal computer (PC), a stationary server device, a minicomputer, a mainframe, a supercomputer, etc.

As shown in FIG. 10, computing device 1002 includes a variety of hardware and software components, including a processor 1010, a storage 1020, a graphics processing unit (GPU) 1042, a neural processing unit (NPU) 1044, one or more input devices 1030, one or more output devices 1050, one or more wireless modems 1060, one or more wired interfaces 1080, a power supply 1082, a location information (LI) receiver 1084, and an accelerometer 1086. Storage 1020 includes memory 1056, which includes non-removable memory 1022 and removable memory 1024, and a storage device 1088. Storage 1020 also stores an operating system 1012, application programs 1014, and application data 1016. Wireless modem(s) 1060 include a Wi-Fi modem 1062, a Bluetooth modem 1064, and a cellular modem 1066. Output device(s) 1050 includes a speaker 1052 and a display 1054. Input device(s) 1030 includes a touch screen 1032, a microphone 1034, a camera 1036, a physical keyboard 1038, and a trackball 1040. Not all components of computing device 1002 shown in FIG. 10 are present in all embodiments, additional components not shown may be present, and in a particular embodiment any combination of the components are present. In examples, components of computing device 1002 are mounted to a circuit card (e.g., a motherboard) of computing device 1002, integrated in a housing of computing device 1002, or otherwise included in computing device 1002. The components of computing device 1002 are described as follows.

In embodiments, a single processor 1010 (e.g., central processing unit (CPU), microcontroller, a microprocessor, signal processor, ASIC (application specific integrated circuit), and/or other physical hardware processor circuit) or multiple processors 1010 are present in computing device 1002 for performing such tasks as program execution, signal coding, data processing, input/output processing, power control, and/or other functions. In examples, processor 1010 is a single-core or multi-core processor, and each processor core is single-threaded or multithreaded (to provide multiple threads of execution concurrently). Processor 1010 is configured to execute program code stored in a computer readable medium, such as program code of operating system 1012 and application programs 1014 stored in storage 1020. The program code is structured to cause processor 1010 to perform operations, including the processes/methods disclosed herein. Operating system 1012 controls the allocation and usage of the components of computing device 1002 and provides support for one or more application programs 1014 (also referred to as “applications” or “apps”). In examples, application programs 1014 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 1010 includes one or more general processors (e.g., CPUs) configured with or coupled to one or more hardware accelerators, such as one or more NPUs 1044 and/or one or more GPUs 1042.

Any component in computing device 1002 can communicate with any other component according to function, although not all connections are shown for ease of illustration. For instance, as shown in FIG. 10, bus 1006 is a multiple signal line communication medium (e.g., conductive traces in silicon, metal traces along a motherboard, wires, etc.) present to communicatively couple processor 1010 to various other components of computing device 1002, although in other embodiments, an alternative bus, further buses, and/or one or more individual signal lines is/are present to communicatively couple components. Bus 1006 represents one or more of any of several types of bus structures, including a memory bus or memory controller, a peripheral bus, an accelerated graphics port, and a processor or local bus using any of a variety of bus architectures.

Storage 1020 is physical storage that includes one or both of memory 1056 and storage device 1088, which store operating system 1012, application programs 1014, and application data 1016 according to any distribution. Non-removable memory 1022 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 1022 includes main memory and is separate from or fabricated in a same integrated circuit as processor 1010. As shown in FIG. 10, non-removable memory 1022 stores firmware 1018 that is present to provide low-level control of hardware. Examples of firmware 1018 include BIOS (Basic Input/Output System, such as on personal computers) and boot firmware (e.g., on smart phones). In examples, removable memory 1024 is inserted into a receptacle of or is otherwise coupled to computing device 1002 and can be removed by a user from computing device 1002. Removable memory 1024 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 1088 are present that are internal and/or external to a housing of computing device 1002 and are or are not removable. Examples of storage device 1088 include a hard disk drive, a SSD, a thumb drive (e.g., a USB (Universal Serial Bus) flash drive), or other physical storage device.

One or more programs are stored in storage 1020. Such programs include operating system 1012, one or more application programs 1014, and other program modules and program data. Examples of such application programs include computer program logic (e.g., computer program code/instructions) for implementing application 104, AI plugin selector 108, AI plugin 110, AI plugin 116, LLM 114, AI model 120, model evaluation system 124, conversation logger 126, evaluation model builder 130, evaluation model 132, answer evaluator 134, LLM 138, training dataset builder 202, prior Q/A pair scorer 204, model trainer 206, judge selector 402, score combiner 404, LLM judge 406, LLM judge 408, dataset filter 802, and/or language model 804, and/or each of the components described therein, as well as any of flowcharts 300, 500, 600, 700, and 900, and/or any individual steps thereof.

Storage 1020 also stores data used and/or generated by operating system 1012 and application programs 1014 as application data 1016. Examples of application data 1016 include web pages, text, images, tables, sound files, video data, and other data. In examples, application data 1016 is sent to and/or received from one or more network servers or other devices via one or more wired or wireless networks. Storage 1020 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 1002 through one or more input devices 1030 and receives information from computing device 1002 through one or more output devices 1050. Input device(s) 1030 includes one or more of touch screen 1032, microphone 1034, camera 1036, physical keyboard 1038 and/or trackball 1040 and output device(s) 1050 includes one or more of speaker 1052 and display 1054. Each of input device(s) 1030 and output device(s) 1050 are integral to computing device 1002 (e.g., built into a housing of computing device 1002) or are external to computing device 1002 (e.g., communicatively coupled wired or wirelessly to computing device 1002 via wired interface(s) 1080 and/or wireless modem(s) 1060). Further input devices 1030 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1054 displays information, as well as operating as touch screen 1032 by receiving user commands and/or other information (e.g., by touch, finger gestures, virtual keyboard, etc.) as a user interface. Any number of each type of input device(s) 1030 and output device(s) 1050 are present, including multiple microphones 1034, multiple cameras 1036, multiple speakers 1052, and/or multiple displays 1054.

In embodiments where GPU 1042 is present, GPU 1042 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 1042 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 1044 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 1028. In an example, NPU 1044 is configured for a data-driven parallel computing and is highly efficient at processing massive multimedia data such as videos and images and processing data for neural networks. NPU 1044 is configured for efficient handling of AI-related tasks, such as speech recognition, background blurring in video calls, photo or video editing processes like object detection, etc.

In embodiments disclosed herein that implement ML models, NPU 1044 can be utilized to execute such ML models, of which MLM 1028 is an example. For instance, where applicable, MLM 1028 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 1044 is used to train MLM 1028. To train MLM 1028, training data is that includes input features (attributes) and their corresponding output labels/target values (e.g., for supervised learning) is collected. A training algorithm is a computational procedure that is used so that MLM 1028 learns from the training data. Parameters/weights are internal settings of MLM 1028 that are adjusted during training by the training algorithm to reduce a difference between predictions by MLM 1028 and actual outcomes (e.g., output labels). In some examples, MLM 1028 is set with initial values for the parameters/weights. A loss function measures a dissimilarity between predictions by MLM 1028 and the target values, and the parameters/weights of MLM 1028 are adjusted to minimize the loss function. The parameters/weights are iteratively adjusted by an optimization technique, such as gradient descent. In this manner, MLM 1028 is generated through training by NPU 1044 to be used to generate inferences based on received input feature sets for particular applications. MLM 1028 is generated as a computer program or other type of algorithm configured to generate an output (e.g., a classification, a prediction/inference) based on received input features, and is stored in the form of a file or other data structure.

In examples, such training of MLM 1028 by NPU 1044 is supervised or unsupervised. According to supervised learning, input objects (e.g., a vector of predictor variables) and a desired output value (e.g., a human-labeled supervisory signal) train MLM 1028. The training data is processed, building a function that maps new data on expected output values. Example algorithms usable by NPU 1044 to perform supervised training of MLM 1028 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 1028 is an LLM, MLM 1028 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 1028 is trained to learn patterns from unlabeled data. For instance, in embodiments where MLM 1028 implements unsupervised learning techniques, MLM 1028 identifies one or more classifications or clusters to which an input belongs. During a training phase of MLM 1028 according to unsupervised learning, MLM 1028 tries to mimic the provided training data and uses the error in its mimicked output to correct itself (i.e., correct weights and biases). In further examples, NPU 1044 perform unsupervised training of MLM 1028 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 1044 need not necessarily be present in all ML model embodiments. In embodiments where ML models are present, any one or more of processor 1010, GPU 1042, and/or NPU 1044 can be present to train and/or execute MLM 1028.

One or more wireless modems 1060 can be coupled to antenna(s) (not shown) of computing device 1002 and can support two-way communications between processor 1010 and devices external to computing device 1002 through network 1004, as would be understood to persons skilled in the relevant art(s). Wireless modem 1060 is shown generically and can include a cellular modem 1066 for communicating with one or more cellular networks, such as a GSM network for data and voice communications within a single cellular network, between cellular networks, or between the mobile device and a public switched telephone network (PSTN). In examples, wireless modem 1060 also or alternatively includes other radio-based modem types, such as a Bluetooth modem 1064 (also referred to as a “Bluetooth device”) and/or Wi-Fi modem 1062 (also referred to as an “wireless adaptor”). Wi-Fi modem 1062 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1064 is configured to communicate with another Bluetooth-capable device according to the Bluetooth short-range wireless technology standard(s) such as IEEE 802.15.1 and/or managed by the Bluetooth Special Interest Group (SIG).

Computing device 1002 can further include power supply 1082, LI receiver 1084, accelerometer 1086, and/or one or more wired interfaces 1080. Example wired interfaces 1080 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 1080 of computing device 1002 provide for wired connections between computing device 1002 and network 1004, or between computing device 1002 and one or more devices/peripherals when such devices/peripherals are external to computing device 1002 (e.g., a pointing device, display 1054, speaker 1052, camera 1036, physical keyboard 1038, etc.). Power supply 1082 is configured to supply power to each of the components of computing device 1002 and receives power from a battery internal to computing device 1002, and/or from a power cord plugged into a power port of computing device 1002 (e.g., a USB port, an A/C power port). LI receiver 1084 is useable for location determination of computing device 1002 and in examples includes a satellite navigation receiver such as a Global Positioning System (GPS) receiver and/or includes other type of location determiner configured to determine location of computing device 1002 based on received information (e.g., using cell tower triangulation, etc.). Accelerometer 1086, when present, is configured to determine an orientation of computing device 1002.

Note that the illustrated components of computing device 1002 are not required or all-inclusive, and fewer or greater numbers of components can be present as would be recognized by one skilled in the art. In examples, computing device 1002 includes one or more of a gyroscope, barometer, proximity sensor, ambient light sensor, digital compass, etc. In an example, processor 1010 and memory 1056 are co-located in a same semiconductor device package, such as being included together in an integrated circuit chip, FPGA, or system-on-chip (SOC), optionally along with further components of computing device 1002.

In embodiments, computing device 1002 is configured to implement any of the above-described features of flowcharts herein. Computer program logic for performing any of the operations, steps, and/or functions described herein is stored in storage 1020 and executed by processor 1010.

In some embodiments, server infrastructure 1070 is present in computing environment 1000 and is communicatively coupled with computing device 1002 via network 1004. Server infrastructure 1070, when present, is a network-accessible server set (e.g., a cloud-based environment or platform). As shown in FIG. 10, server infrastructure 1070 includes clusters 1072. Each of clusters 1072 comprises a group of one or more compute nodes and/or a group of one or more storage nodes. For example, as shown in FIG. 10, cluster 1072 includes nodes 1074. Each of nodes 1074 are accessible via network 1004 (e.g., in a “cloud-based” embodiment) to build, deploy, and manage applications and services. In examples, any of nodes 1074 is a storage node that comprises a plurality of physical storage disks, SSDs, and/or other physical storage devices that are accessible via network 1004 and are configured to store data associated with the applications and services managed by nodes 1074.

Each of nodes 1074, as a compute node, comprises one or more server computers, server systems, and/or computing devices. For instance, a node 1074 in accordance with an embodiment includes one or more of the components of computing device 1002 disclosed herein. Each of nodes 1074 is configured to execute one or more software applications (or “applications”) and/or services and/or manage hardware resources (e.g., processors, memory, etc.), which are utilized by users (e.g., customers) of the network-accessible server set. In examples, as shown in FIG. 10, nodes 1074 includes a node 1046 that includes storage 1048 and/or one or more of a processor 1058 (e.g., similar to processor 1010, GPU 1042, and/or NPU 1044 of computing device 1002). Storage 1048 stores application programs 1076 and application data 1078. Processor(s) 1058 operate application programs 1076 which access and/or generate related application data 1078. In an implementation, nodes such as node 1046 of nodes 1074 operate or comprise one or more virtual machines, with each virtual machine emulating a system architecture (e.g., an operating system), in an isolated manner, upon which applications such as application programs 1076 are executed.

In embodiments, one or more of clusters 1072 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 1072 are included in a datacenter in a distributed collection of datacenters. In embodiments, exemplary computing environment 1000 comprises part of a cloud-based platform.

In an embodiment, computing device 1002 accesses application programs 1076 for execution in any manner, such as by a client application and/or a browser at computing device 1002.

In an example, for purposes of network (e.g., cloud) backup and data security, computing device 1002 additionally and/or alternatively synchronizes copies of application programs 1014 and/or application data 1016 to be stored at network-based server infrastructure 1070 as application programs 1076 and/or application data 1078. In examples, operating system 1012 and/or application programs 1014 include a file hosting service client configured to synchronize applications and/or data stored in storage 1020 at network-based server infrastructure 1070.

In some embodiments, on-premises servers 1092 are present in computing environment 1000 and are communicatively coupled with computing device 1002 via network 1004. On-premises servers 1092, when present, are hosted within an organization's infrastructure and, in many cases, physically onsite of a facility of that organization. On-premises servers 1092 are controlled, administered, and maintained by IT (Information Technology) personnel of the organization or an IT partner to the organization. Application data 1098 can be shared by on-premises servers 1092 between computing devices of the organization, including computing device 1002 (when part of an organization) through a local network of the organization, and/or through further networks accessible to the organization (including the Internet). Furthermore, in examples, on-premises servers 1092 serve applications such as application programs 1096 to the computing devices of the organization, including computing device 1002. Accordingly, in examples, on-premises servers 1092 include storage 1094 (which includes one or more physical storage devices such as storage disks and/or SSDs) for storage of application programs 1096 and application data 1098 and include a processor 1090 (e.g., similar to processor 1010, GPU 1042, and/or NPU 1044 of computing device 1002) for execution of application programs 1096. In some embodiments, multiple processors 1090 are present for execution of application programs 1096 and/or for other purposes. In further examples, computing device 1002 is configured to synchronize copies of application programs 1014 and/or application data 1016 for backup storage at on-premises servers 1092 as application programs 1096 and/or application data 1098.

Embodiments described herein may be implemented in one or more of computing device 1002, network-based server infrastructure 1070, and on-premises servers 1092. For example, in some embodiments, computing device 1002 is used to implement systems, clients, or devices, or components/subcomponents thereof, disclosed elsewhere herein. In other embodiments, a combination of computing device 1002, network-based server infrastructure 1070, and/or on-premises servers 1092 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1020. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1014) are stored in storage 1020. Such computer programs can also be received via wired interface(s) 1060 and/or wireless modem(s) 1060 over network 1004. Such computer programs, when executed or loaded by an application, enable computing device 1002 to implement features of embodiments discussed herein. Accordingly, such computer programs represent controllers of the computing device 1002.

Embodiments are also directed to computer program products comprising computer code or instructions stored on any computer-readable medium or computer-readable storage medium. Such computer program products include the physical storage of storage 1020 as well as further physical storage types.

### IV. Additional Example Embodiments

A system for evaluating the performance of a question-answering model is disclosed herein. The system includes: a processor; and a memory device that stores program code structured to cause the processor to: obtain a set of prior question-answer pairs, each prior question-answer pair comprising a question and an associated answer; provide each prior question-answer pair of the set to a large language model (LLM) to obtain an evaluation score for the prior question-answer pair; train an evaluation model based on features that comprise information from each prior question-answer pair and labels based on the evaluation score for each prior question-answer pair; obtain a current question-answer pair; and generate a current evaluation score for the current question-answer pair by applying the current question-answer pair to the evaluation model.

In one implementation of the foregoing system, the program code is further structured to cause the processor to: provide each prior question-answer pair of the set to a plurality of LLMs, each LLM returning a respective evaluation score for the prior question-answer pair; and train the evaluation model based on a combination of the evaluation scores for each prior question-answer pair.

In another implementation of the foregoing system, the current question-answer pair comprises a current question and a current answer, the current question provided to a trained model and the current answer returned by the trained model.

In another implementation of the foregoing system, the current evaluation score is indicative of a quality of the current answer to the current question.

In another implementation of the foregoing system, each question of the prior question-answer pairs was provided to a trained model, and each associated answer was returned by the trained model.

In another implementation of the foregoing system, the trained model is a different model than the LLM.

In another implementation of the foregoing system, the program code is structured to cause the processor to provide each prior question-answer pair of the set to the LLM by: generating a prompt that includes the prior question and prior answer of each prior question-answer pair to the LLM; and receiving the evaluation score for the question-answer pair from the LLM.

In another implementation of the foregoing system, the program code is further structured to cause the processor to perform an action in response to generating the current evaluation score, the action comprising at least one of: providing an indication relating to a quality of the current answer to a trained model that generated the current answer; or providing an indication relating to the quality of the current answer to a planner of a question-answering system that selected the trained model to generate the current answer.

In another implementation of the foregoing system, the program code is further structured to cause the processor to: provide, to a user interface, a rating based on the current evaluation score and the current answer.

In another implementation of the foregoing system, the program code is further structured to cause the processor to: obtain a chat history that identifies conversations between users and a question-answering system; and select the set of prior question-answer pairs from the conversations based on a filtering criteria.

In another implementation of the foregoing system, the evaluation model is a regression model.

A method for evaluating the performance of a question-answering model is disclosed herein. The method includes: obtaining a set of prior question-answer pairs, each prior question-answer pair comprising a question and an associated answer; providing each prior question-answer pair of the set to a large language model (LLM) to obtain an evaluation score for the prior question-answer pair; training an evaluation model based on features that comprise information from each prior question-answer pair and labels based on the evaluation score for each prior question-answer pair; obtaining a current question-answer pair; generating a current evaluation score for the current question-answer pair by applying the current question-answer pair to the evaluation model.

In one implementation of the foregoing method, the method further includes: providing each prior question-answer pair of the set to a plurality of LLMs, each LLM returning a respective evaluation score for the prior question-answer pair; and training the evaluation model based on a combination of the evaluation scores for each prior question-answer pair.

In another implementation of the foregoing method, the current evaluation score is indicative of a quality of a current question of the current question-answer pair to a current answer of the current question-answer pair.

In another implementation of the foregoing method, the method further includes: performing an action in response to generating the current evaluation score, the action comprising at least one of: providing an indication relating to a quality of the current answer to a trained model that generated the current answer; or providing an indication relating to the quality of the current answer to a planner of a question-answering system that selected the trained model to generate the current answer.

In another implementation of the foregoing method, the method further includes: obtaining a chat history that identifies conversations between users and a question-answering system; selecting the set of prior question-answer pairs from the conversations based on a filtering criteria.

A computer-readable storage medium is disclosed herein. The computer-readable storage medium has computer program code recorded thereon that when executed by at least one processor causes the at least one processor to perform a method comprising: obtaining a set of prior question-answer pairs, each prior question-answer pair comprising a question and an associated answer; providing each prior question-answer pair of the set to a large language model (LLM) to obtain an evaluation score for the prior question-answer pair; training an evaluation model based on features that comprise information from each prior question-answer pair and labels based on the evaluation score for each prior question-answer pair; obtaining a current question-answer pair; and generating a current evaluation score for the current question-answer pair by applying the current question-answer pair to the evaluation model.

In one implementation of the foregoing computer-readable storage medium, the method further comprises: providing each prior question-answer pair of the set to a plurality of LLMs, each LLM returning a respective evaluation score for the prior question-answer pair; and training the evaluation model based on a combination of the evaluation scores for each prior question-answer pair.

In another implementation of the foregoing computer-readable storage medium, the current evaluation score is indicative of a quality of a current question of the current question-answer pair to a current answer of the current question-answer pair.

In another implementation of the foregoing computer-readable storage medium, the method further comprises: performing an action in response to generating the current evaluation score, the action comprising at least one of: providing an indication relating to a quality of the current answer to a trained model that generated the current answer; or providing an indication relating to the quality of the current answer to a planner of a question-answering system that selected the trained model to generate the current answer.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the claimed embodiments should not be limited by any of the above-described exemplary embodiments, but should be defined only in accordance with the following claims and their equivalents.

What is claimed is:

1. A system for evaluating the performance of a question-answering model, the system comprising:
a processor; and
a memory device that stores program code structured to cause the processor to:
obtain a set of prior question-answer pairs, each prior question-answer pair comprising a question and an associated answer;
provide each prior question-answer pair of the set to a large language model (LLM) to obtain an evaluation score for the prior question-answer pair;
train an evaluation model based on features that comprise information from each prior question-answer pair and labels based on the evaluation score for each prior question-answer pair;
obtain a current question-answer pair; and
generate a current evaluation score for the current question-answer pair by applying the current question-answer pair to the evaluation model.

2. The system of claim 1, wherein the program code is further structured to cause the processor to:
provide each prior question-answer pair of the set to a plurality of LLMs, each LLM returning a respective evaluation score for the prior question-answer pair; and
train the evaluation model based on a combination of the evaluation scores for each prior question-answer pair.

3. The system of claim 1, wherein the current question-answer pair comprises a current question and a current answer, the current question provided to a trained model and the current answer returned by the trained model.

4. The system of claim 3, wherein the current evaluation score is indicative of a quality of the current answer to the current question.

5. The system of claim 1, wherein each question of the prior question-answer pairs was provided to a trained model, and each associated answer was returned by the trained model.

6. The system of claim 5, wherein the trained model is a different model than the LLM.

7. The system of claim 1, wherein the program code is structured to cause the processor to provide each prior question-answer pair of the set to the LLM by:
generating a prompt that includes the prior question and prior answer of each prior question-answer pair to the LLM; and
receiving the evaluation score for the question-answer pair from the LLM.

8. The system of claim 1, wherein the program code is further structured to cause the processor to perform an action in response to generating the current evaluation score, the action comprising at least one of:
providing an indication relating to a quality of the current answer to a trained model that generated the current answer; or
providing an indication relating to the quality of the current answer to a planner of a question-answering system that selected the trained model to generate the current answer.

9. The system of claim 1, wherein the program code is further structured to cause the processor to:
provide, to a user interface, a rating based on the current evaluation score and the current answer.

10. The system of claim 1, wherein the program code is further structured to cause the processor to:
obtain a chat history that identifies conversations between users and a question-answering system; and
select the set of prior question-answer pairs from the conversations based on a filtering criteria.

11. The system of claim 1, wherein the evaluation model is a regression model.

12. A method for evaluating the performance of a question-answering model, comprising:
obtaining a set of prior question-answer pairs, each prior question-answer pair comprising a question and an associated answer;
providing each prior question-answer pair of the set to a large language model (LLM) to obtain an evaluation score for the prior question-answer pair;
training an evaluation model based on features that comprise information from each prior question-answer pair and labels based on the evaluation score for each prior question-answer pair;
obtaining a current question-answer pair; and
generating a current evaluation score for the current question-answer pair by applying the current question-answer pair to the evaluation model.

13. The method of claim 12, further comprising:
providing each prior question-answer pair of the set to a plurality of LLMs, each LLM returning a respective evaluation score for the prior question-answer pair; and
training the evaluation model based on a combination of the evaluation scores for each prior question-answer pair.

14. The method of claim 12, wherein the current evaluation score is indicative of a quality of a current question of the current question-answer pair to a current answer of the current question-answer pair.

15. The method of claim 12, further comprising:
performing an action in response to generating the current evaluation score, the action comprising at least one of:
providing an indication relating to a quality of the current answer to a trained model that generated the current answer; or
providing an indication relating to the quality of the current answer to a planner of a question-answering system that selected the trained model to generate the current answer.

16. The method of claim 12, further comprising:
obtaining a chat history that identifies conversations between users and a question-answering system; and
selecting the set of prior question-answer pairs from the conversations based on a filtering criteria.

17. A computer-readable storage medium having computer program code recorded thereon that when executed by at least one processor causes the at least one processor to perform a method comprising:
obtaining a set of prior question-answer pairs, each prior question-answer pair comprising a question and an associated answer;
providing each prior question-answer pair of the set to a large language model (LLM) to obtain an evaluation score for the prior question-answer pair;
training an evaluation model based on features that comprise information from each prior question-answer pair and labels based on the evaluation score for each prior question-answer pair;
obtaining a current question-answer pair; and
generating a current evaluation score for the current question-answer pair by applying the current question-answer pair to the evaluation model.

18. The computer-readable storage medium of claim 17, wherein the method further comprises:
providing each prior question-answer pair of the set to a plurality of LLMs, each LLM returning a respective evaluation score for the prior question-answer pair; and
training the evaluation model based on a combination of the evaluation scores for each prior question-answer pair.

19. The computer-readable storage medium of claim 17, wherein the current evaluation score is indicative of a quality of a current question of the current question-answer pair to a current answer of the current question-answer pair.

20. The computer-readable storage medium of claim 17, wherein the method further comprises:
performing an action in response to generating the current evaluation score, the action comprising at least one of:
providing an indication relating to a quality of the current answer to a trained model that generated the current answer; or
providing an indication relating to the quality of the current answer to a planner of a question-answering system that selected the trained model to generate the current answer.
